(19) United States
(12) Patent Application Publication
(10) Pub. No.: US 2005/0188610 A1
(43) Pub. Date: Sep. 1, 2005

(54) Growing vined plants

(75) Inventors: David Shaver, Kingsbury, TX (US); Jean M. Foissac, Jalisco (MX)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Desert Glory, Ltd., San Antonio, TX (US)

(21) Appl. No.: 10/789,444

(22) Filed: Feb. 27, 2004

(51) Int. Cl. A01G 17/06

(52) U.S. Cl. 47/46; 47/58.1 SE

(57) ABSTRACT

According to a feature of the invention, a flexible material, such as string, is secured at the base of the plant and also secured to a height taller than the plant. As the plant grows, its heads or vines are twisted in pairs around the respectively secured strings. As a result, the plant produces less foliage, bears more fruit per area of land, and grows to maturity in less time than with many conventional twisting techniques.

### TECHNICAL FIELD

This application relates in general to the mass production of produce and more specifically to systems and methods for increasing yield.

### BACKGROUND OF THE INVENTION

Cultivating produce requires a high level of care and attention. Over the years, gardeners have developed various techniques to ensure the best growing environment for their plants. When growing extensive volumes of produce, it is often difficult to maintain the high level of care required to ensure the best growing environment. Moreover, when growing produce in mass quantities, the goal is to obtain the highest volume of produce per area of land, and for the produce to taste as fresh and flavorful as if it were grown in a home garden. Further, mass producers of vegetables and fruits desire to cultivate and harvest plants in a minimal amount of time. Consequently, processes and devices have been developed to provide a repeatable technique for producing the maximum yield in a minimal amount of time while maintaining home grown flavor.

In the specific case of tomato plants, the dilemma of maximizing plant yield per area of land has been addressed through the use of various twisting techniques. These twisting techniques allow the plant to produce more fruit while reducing the amount of time required between planting and harvesting. One conventional growing technique uses string as a method to cause the tomato plant to bear more fruit. To ignite an increase in the volume of fruit produced, a string is secured at the base of the plant and is twisted around each vine. The other end of the string is held above the end of the vine. Twisting string around the tomato plant in this way causes it to produce less foliage and more fruit.

While the conventional twisting methods cause plants to yield more fruit, these methods do, however, have drawbacks. These drawbacks include an upper-limit volume of fruit that can be harvested per area of land and a lower-limit length of time between planting and harvesting. Mass producers of produce have been seeking ways of surpassing the upper and lower-limit thresholds of the conventional twisting techniques.

### BRIEF SUMMARY OF THE INVENTION

The present invention is directed to methods for growing a plant comprising planting a plant in a growth medium, twisting at least two plant vines together to form a growing unit, and maintaining the growing unit during the growth and production cycles of the plant.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 shows a diagram of a prior art conventional twisting technique; and

FIG. 2 depicts an example of an embodiment of the present invention.

### DETAILED DESCRIPTION

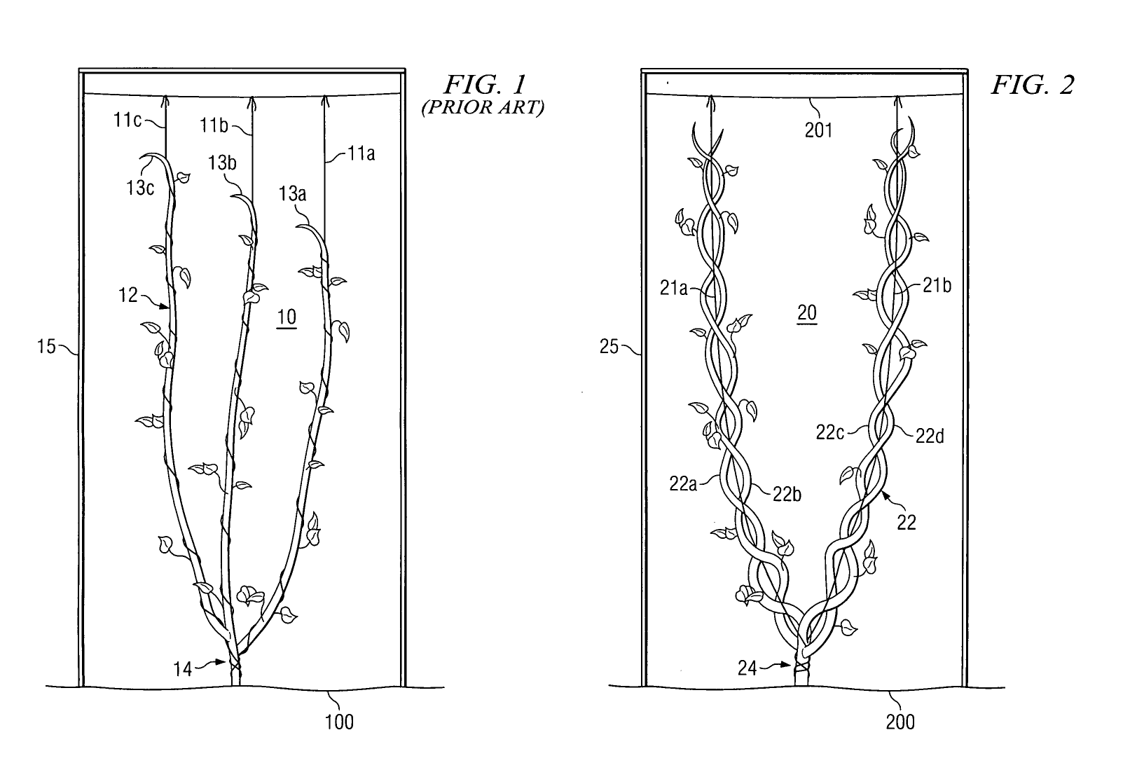

FIG. 1 illustrates a system 10, which shows the conventional method of twisting plant 12 to increase its fruit while reducing its production time. It is important to note that plant 12 can be any blooming or produce plant that has vines 13a-13c. Further note that plant 12 can grow from various seeds, as well as a bud or a graft from another plant. The illustrated system includes plant 12 with several vines 13a-13c, growth medium 100 and flexible material 11a-11c. Plant 12 is planted in growth medium 100. Growth medium 100 can be any element used to enable the plant 12 to grow, such as soil, sand, fertilizer, rocks, water, and combinations thereof.

In the conventional twisting technique, plant 12 is grown in growth medium 100 and is groomed to produce multiple vines 13. For example, FIG. 1 illustrates plant 12 with three vines 13a-13c. Flexible material 11a-11c, such as string, is connected to base 14 of plant 12 and twisted around each vine 13a-13c of plant 12. There is one string 11a-11c per vine 13a-13c, also referred to as head. Each string 11a-11c is twisted around its respective vine 13a-13c. For example, string 11a is twisted around vine 13a, string 11b is twisted around vine 13b, and string 11c is twisted around 13c. This technique causes a reduction in foliage and an increase in the amount of fruit produced per hectare. It is important to note that the fruit produced can be any type of produce which grows on a vined plant or any type of bloom on a vined plant. This growing technique-typically yields 180,000 pounds per hectare from 1500 plants.

To clarify the underlying reason why securing string in this fashion causes a plant to produce more fruit, a discussion of photosynthesis and pruning techniques is useful.

Photosynthesis is the process by which plants transform light into energy. Photosynthesis occurs when the light falls on the plant's foliage, and thus it would seem that the greater the foliage, then the greater the amount of stored energy. For the specific case of tomato plants, initially in a growing cycle, the plant bears stems or branches along with leaves. The leaves produce and store that energy for later use in growing fruit.

Plant pruning is beneficial in preventing a plant's leaves from consuming the sugars produced during photosynthesis. Pruning must be done with care so as to maximize photosynthesis while reducing unnecessary sugar consumption. With proper pruning, the plant will use the stored sugar to produce fruit rather than additional foliage. Twisting techniques for vined plants, combined with pruning, increase fruit yield beyond that reached by pruning alone. This twisting technique forces a plant's foliage to consume a minimal amount of sugar by causing the plant's vines to compete for nutrients.

Twisting of the heads causes more stress by creating competition on the growing heads. This causes the plants to become more generative or reproductive, resulting in more tomatoes per plant, rather than vegetative (i.e., more leaves and less fruit). The twisting technique forces leaves, because of competition, to the light source which results in a net increase in photosynthesis. More photosynthesis allows the growth of more tomato clusters, and the synthesized nutrients result in more yield.

FIG. 2 illustrates a system 20 of the present invention. System 20 comprises flexible material 21a-21b, plant 22 and growth medium 200. Material 21a, 21b can be any structure, for example, wire, string, or metal rod held up, if necessary, by trellis 25 or by any other structure. For the sake of simplicity, material 21a, 21b will be referred to as string 21. String 21 is secured at base 24 of plant 22. The opposite end of string 21 is secured at a height taller than that of plant 22. In the embodiment shown, strings 21a and 21b are held up by a top rail 201 of trellis 25. Vines 22a-22d are coupled into pairs. For example, vines 22a and 22b are coupled together and vines 22c and 22d are coupled together. Each of the pairs of vines are then twisted together to form a growing unit. For example, vines 22a and 22b are twisted together around string 21a. Likewise vines 22c and 22d are twisted together around string 21b. This arrangement has been shown to yield 200,000 pounds of tomatoes per Hectare. The plants are spaced to achieve 18,000 plants per Hectare. Thus, using the system and methods discussed above, approximately 3000 more plants can be grown in the same space.

Note that in FIG. 2 the heads are paired, but more heads could be added to each twisted set, if desired. Also, note that the vines could be horizontal as well as vertical. The vines may be directed straight upward or at an angle (as shown in FIG. 2). The vines may also be directed downward.

Further, note that the vines are shown from a single plant. However, more plants may be used. For example, a single vine from each of two plants may be twisted together to form a growing unit. Moreover, multiple plants may be arranged side by side (e.g., in a row) with the vine of one plant twisted with a vine of an adjacent plant.

This twisting technique improves yield by allowing more growth heads per plant. Each plant becomes more compact, allowing more light to penetrate the leaves of the plant. More growth heads per plant results in more clusters per plant. Thus, there is more yield in a given greenhouse space.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method for growing a plant comprising the steps of:
planting said plant in a growth medium;
twisting at least two plant vines of said plant together to form a growing unit; and
maintaining said growing unit during the growth and production cycles of said plant.

2. The method of claim 1 wherein said maintaining step comprises the steps of:
securing one end of a flexible material at the base of said plant; and
twisting said flexible material around said growing unit.

3. The method of claim 1 wherein said twisting step comprises the step of:
twisting said at least two plant vines together around a flexible material.

4. A yield maximization system comprising:
a growth medium for sustaining the growth of a plant, said plant having vines growing from a single root system; and
supports for twisting at least pairs of said vines around individual ones of said supports.

5. The yield maximization system of claim 4 wherein said supports comprise:
a flexible material having one end tied around the base of said plant and the opposite end supported above said vines.

6. A method for growing a plant, said method comprising:
twisting at least two plant vines of said plant around a flexible material; and
securing said flexible material, wherein said at least two plant vines are twisted vertically around said flexible material.

7. The method of claim 6 wherein said flexible material comprises string.

8. The method of claim 6 wherein said flexible material comprises a rod.

9. A method for growing a plant comprising:
planting a plant in a growth medium, wherein plant vines are produced from said plant; and
attaching at least a pair of said plant vines to one another with a flexible material, wherein said at least a pair of said plant vines are twisted together around said flexible material.

10. The method of claim 9, wherein said attaching step comprises:
securing one end of said flexible material at the base of said plant; and
securing the opposite end of said flexible material at a height taller than said plant.
